(19) United States
(12) Patent Application Publication
(10) Pub. No.: US 2024/0256967 A1
(43) Pub. Date: Aug. 1, 2024

(54) CLASSIFIER TRAINING USING SYNTHETIC TRAINING DATA SAMPLES

(71) Applicant: MASTERCARD INTERNATIONAL INCORPORATED, PURCHASE, NY (US)

(72) Inventors: Anubha Pandey, Bikaner (IN); Aman Gupta, Chandauli (IN); Deepak Bhatt, Dehradun (IN); Emmanuel Gama Ibarra, Hoboken, NJ (US); Ganesh Nagendra Prasad, Stamford, CT (US); Harsimran Bhasin, Delhi (IN); Ross Harris, London (GB); Srinivasan Chandrasekharan, Princeton, NJ (US); Tanmoy Bhowmik, Bangalore (IN)

(21) Appl. No.: 18/428,925

(22) Filed: Jan. 31, 2024

(30) Foreign Application Priority Data
Jan. 31, 2023 (IN) 202311006293

(51) Int. Cl. G06N 20/00

(52) U.S. Cl. CPC G06N 20/00

(57) ABSTRACT

A classifier is trained to classify business supplier relationships using synthetic training data samples. Real training data samples are collected and transformed into sample encodings using an encoder. The real training data samples include feature data associated with health class indicators indicative of relationships between suppliers and service providers. A set of synthetic training data samples is generated from the sample encodings using a generator and discrimination feedback data is generated using a discriminator based on the real training data samples and the synthetic training data samples. The discrimination feedback data is used to train the generator. A classifier model is trained to classify suppliers with health class indicators using the set of synthetic training data samples. The use of the encoder, generator, and discriminator enables the generation of accurate synthetic training data that represents the source distribution of real data which are often partially observed.

### BACKGROUND

Modern artificial intelligence (AI) modeling can be used to predict behavior in business environments. Such predictions can enable more effective decision-making and/or preemptive actions by parties in business relationships. However, in many cases, available data for training models to predict such behavior is lacking in quantity and/or quality, thus making such uses of AI modeling difficult or impossible. For instance, available data for use as training data is often imbalanced, such that classification of business relationships based on the available data cannot be accurately modeled.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for training a classifier model to classify business supplier relationships using synthetic training data samples is described. Real training data samples are collected and transformed into sample encodings using an encoder. A set of synthetic training data samples are generated from the sample encodings using a generator and discrimination feedback data is generated using a discriminator based on the real training data samples and the synthetic training data samples. The discrimination feedback data is used to train the generator. Then, a classifier model is trained to classify suppliers with health class indicators using the set of synthetic training data samples.

### BRIEF DESCRIPTION OF THE DRAWINGS

The present description will be better understood from the following detailed description read in light of the accompanying drawings, wherein:

FIG. 1 is a block diagram illustrating an example system configured to generate synthetic training data samples and use those samples to train a classifier to generate health indicators based on feature data;

FIG. 2 is a diagram illustrating an example configuration and training of a Variational autoencoder in a system such as the system of FIG. 1;

FIG. 3 is a diagram illustrating an example configuration and training of a Generative Adversarial Network in a system such as the system of FIG. 1;

FIG. 4 is a diagram illustrating an example configuration and training of a Graph C Network-based classifier in a system such as the system of FIG. 1;

FIG. 5 is a flowchart illustrating an example method for training a classifier model to classify suppliers with health class indicators:

FIG. 6 is a flowchart illustrating an example method for iteratively training a series of models for classifying suppliers with health class indicators; and

FIG. 7 illustrates an example computing apparatus as a functional block diagram.

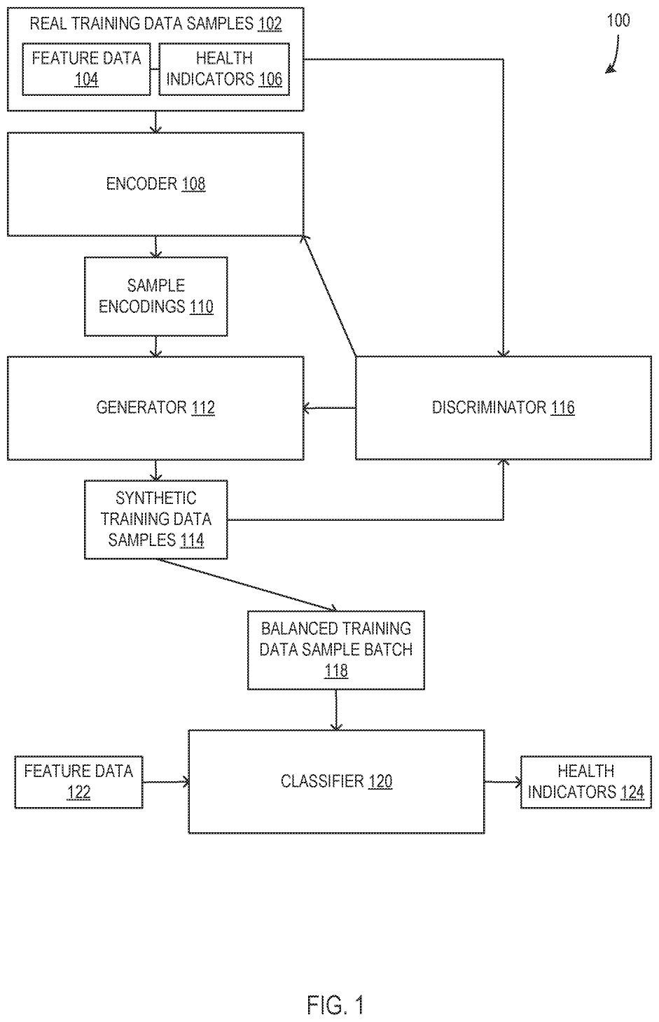

Corresponding reference characters indicate corresponding parts throughout the drawings. In FIGS. 1 to 7, the systems are illustrated as schematic drawings. The drawings may not be to scale. Any of FIGS. 1 to 7 may be combined into a single example or embodiment.

### DETAILED DESCRIPTION

A computerized method and system generates class-balanced synthetic training data samples, and uses those generated samples to train a classifier model to classify relationship health between suppliers and service providers. An encoder, such as a Variational Autoencoder (VAE), generates sample encodings from a set of real training data samples. In some examples, the real training data samples include feature data associated with health class indicators that are indicative of a likelihood of a supplier to continue using a service provided by a service provider. A generator is used to generate synthetic training data samples from the sample encodings. A discriminator attempts to distinguish between the synthetic and real training data samples to generate discrimination feedback data. The generator is then trained based on the discrimination feedback data to improve the accuracy of the synthetic training data samples it generates. In some examples, the generator and the discriminator are components of a Generative Adversarial Network (GAN). Further, a classifier model is trained to classify suppliers with health class indicators using the set of synthetic training data samples. The classifier model is then used to classify suppliers with health class indicators using the set of synthetic training data samples.

The disclosure operates in an unconventional manner at least by using the combination of an encoder and an adversarially trained generator and discriminator to generate a sufficient quantity of synthetic training data samples that are class-balanced and distributed normally across the possible distribution space. The use of a VAE in combination with a GAN as described enables the generation of such synthetic training data from relatively small real data sets that are otherwise class-unbalanced. Thus, the disclosure improves the computational efficiency of training the described classifier model, and/or the quality and/or accuracy of the classifier model once it has been trained.

In many cases, use of a GAN alone to generate sets of data from small and/or unbalanced training sets results in “mode collapse”. Mode collapse is when the GAN generates a particularly plausible example of synthetic data and, as a result, the generator of the GAN is trained to only generate synthetic data that is like that example. This causes the output of the GAN to become very narrow and less useful for training a classifier model because the classifier model must be able to classify feature data that includes a variety of different types of training data samples, rather than the single type that the GAN becomes trained to generate.

Further, VAE-based models are capable of generating many diverse encoding samples, but there is often a significant difference between the generated samples and the real sample data. These issues of GANs and VAEs are overcome by integrating them, such that the VAE generates diverse, normalized encoding distributions that are used as the input to the GAN, enabling the generator of the GAN to be trained to generate accurate synthetic training data samples without collapsing into generating data of a single mode.

The disclosure further describes the use of a Graph Convolutional Network (GCN)-based binary classifier to learn discriminative features from input graph-structured data that is generated using the synthetic training data samples generated by the GAN. This type of classifier is configured to learn features of input data by analyzing neighboring nodes within the graph-structured data, enabling the classifier to be efficiently trained and resulting in the accurate classification of input data by the trained classifier.

It should be understood that, while many examples herein describe the disclosure being used with feature data associated with business relationships between suppliers and/or other similar entities and service providers, in other examples, the disclosure is applied to data associated with other types of business relationships or even other types of classification problems for which associated feature data can be collected. For instance, in other examples, the disclosure is applied to model the behavior of employees of a company, repeat customers shopping at stores, or the like.

FIG. 1 is a block diagram illustrating a system 100 configured to generate synthetic training data samples 114 and use those samples to train a classifier 120 to generate health indicators 124 based on feature data 122. In some examples, real training data samples 102 are encoded using an encoder 108 to generate sample encodings 110. The sample encodings 110 are used to generate synthetic training data samples 114 using a generator 112. A discriminator 116 is used with the real training data samples 102 and the synthetic training data samples 114 to attempt to classify the samples 102 and 114 as real or synthetic. Based on the success of the discriminator 116, the encoder 108, generator 112, and/or discriminator 116 are trained to improve their performance as described herein. When the performance of the discriminator 116 indicates that the encoder 108 and generator 112 are trained to generate accurate synthetic training data samples 114 based on the real training data samples 102, those synthetic training data samples 114 are used as a balanced training data sample batch 118 for training the classifier 120 as described herein. Once trained, the classifier 120 is provided feature data 122 of a supplier or other entity and generates a health indicator 124 of that supplier or other entity based on that feature data 122.

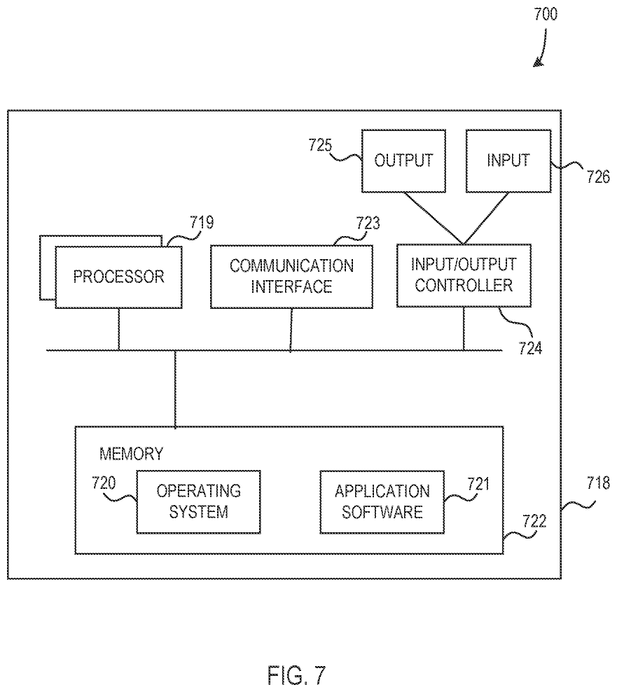

In some examples, the system 100 includes a computing device, such as the computing device of FIG. 7. Further, in some examples, the system 100 includes multiple computing devices that are configured to communicate with each other via one or more communication networks (e.g., an intranet, the Internet, a cellular network, other wireless network, other wired network, or the like). In some such examples, entities of the system 100 are configured to be distributed between the multiple computing devices and to communicate with each other via network connections. For instance, in an example, the encoder 108, generator 112, and discriminator 116 are located and/or executed on a first computing device or set of computing devices while the classifier 120 is located and/or executed on a second computing device or set of computing devices. The generator 112 and the classifier 120 are then configured to communicate with each other via a network connection as described herein. In other examples, other arrangements or organizations of multiple computing devices are used in the system 100 without departing from the description.

The real training data samples 102 are collected from existing and/or past suppliers or other entities that make use of a service provided by a service provider. For each supplier for which real training data samples 102 are obtained, feature data 104 of the supplier is mapped to or otherwise associated with a health indicator 106 of that supplier. In some examples, the feature data 104 includes transaction data associated with transactions of the supplier. Further, in some examples, a health indicator 106 is indicative of a likelihood that the associated supplier will continue to use the service provided by the service provider, or a likelihood of discontinuity. A “healthy” health indicator 106 indicates that the supplier is likely to continue to use the service and an “unhealthy” health indicator 106 indicates that the supplier is unlikely to continue to use the service.

In some such examples, the health indicator 106 is a binary value that indicates whether the supplier is “healthy” or “unhealthy”. Alternatively, or additionally, the health indicator 106 includes a non-binary value, such as an integer value, letter rating value, or the like, that indicates the health of the supplier in a more granular way. For instance, in an example, the health indicator 106 includes a percentage value from 1-100%, with values over 50% indicating that the supplier is healthy and values 50% and below indicating the supplier is unhealthy.

Further, it should be understood that the feature data 104 of a supplier includes data that is known to correlate with a relative health of a supplier. For instance, in an example where a supplier is using the services of a credit card company for transaction processing, the feature data 104 includes transaction data, such that the quantity of transactions over time and/or other transaction-related features can be analyzed with respect to the health indicator 106, which is known based on actual behavior of the supplier (e.g., whether the supplier has continued to use the service or has stopped using the service). In other examples, other types of data are used as the feature data 104 without departing from the description.

Further, it should be understood that, in many cases, the real training data samples 102 are a class-imbalanced set of training data, such that the quantity of suppliers represented in the real training data samples 102 that are “healthy” substantially outnumbers the quantity of suppliers represented in the real training data samples 102 that are “unhealthy”. Such a class-imbalanced set of training data cannot be used to successful train a classifier such as classifier 120 in some examples, and in other examples, such an imbalance presents significant challenges to training such a classifier. However, the system 100 addresses such challenges by first training a model network of the encoder 108 and the generator 112 to generate accurate synthetic training data samples 114 in a class-balanced way, such that those samples 114 can be used to train the classifier 120 as described herein.

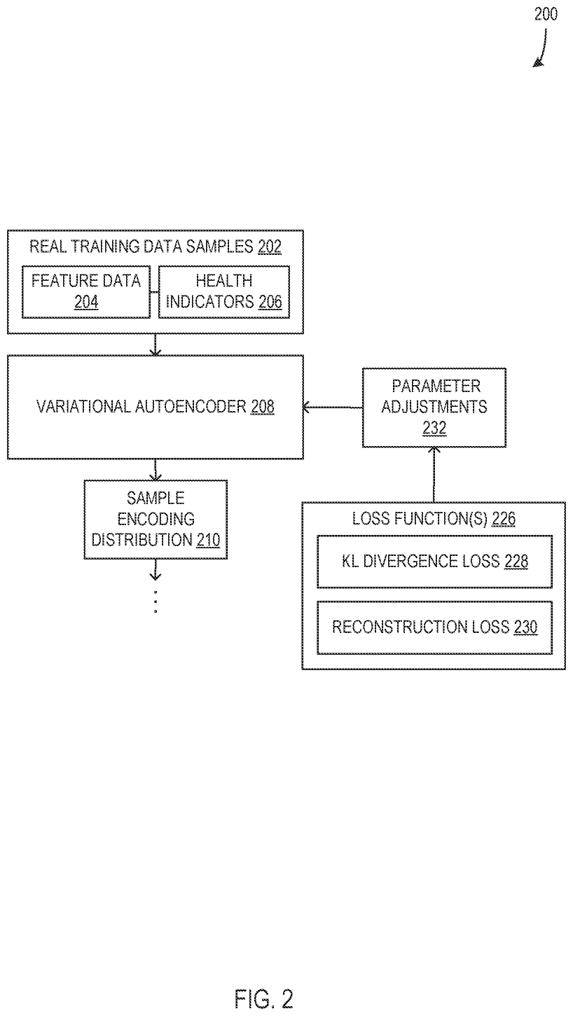

The encoder 108 includes hardware, firmware, and/or software configured to generate sample encodings 110 from the real training data samples 102. In some examples, the encoder 108 is configured as a model that can be trained using machine learning techniques to improve its performance based on some defined measure of performance. Further, in some examples, the encoder 108 is a Variational Autoencoder (VAE). In such examples, the VAE is configured to generate encodings 110 that are distributed in regular way over the encoding space during training, such that the latent space of the encodings 110 provide broad, flexible coverage of the space. The encoder 108 as a VAE is described in greater detail below with respect to FIG. 2.

In some examples, the sample encodings 110 include data values in vector formats or other similar formats that are generated by the encoder 108 during the encoding of the real training data samples 102. Feature data values of the feature data 104 and/or the health indicators 106 are analyzed in the encoder 108 and operations within the encoder 108 are performed to generate a set of data values that make up the sample encodings 110. Further, in some examples, the encoder 108 is configured to transform, or encode, categorical data values in the feature data 104 and associated health indicators 106 into numerical data of the sample encodings 110. Additionally, or alternatively, the operations of the encoder 108 that are used to generate the sample encodings 110 include weight parameters that affect how the sample encodings 110 are generated. In such examples, these weight parameters are adjusted during training of the encoder 108 to improve the capability of the encoder 108 to generate sample encodings 110 that accurately represent the feature data 104 and/or health indicators 106 of the real training data samples 102.

Further, in some examples, the sample encodings 110 generated by the encoder 108 include sample encodings associated with generated synthetic data, rather than the real training data samples 102. Additionally, or alternatively, the sample encodings 110 include, and/or are made up of, an encoding distribution as described further below with respect to FIG. 2.

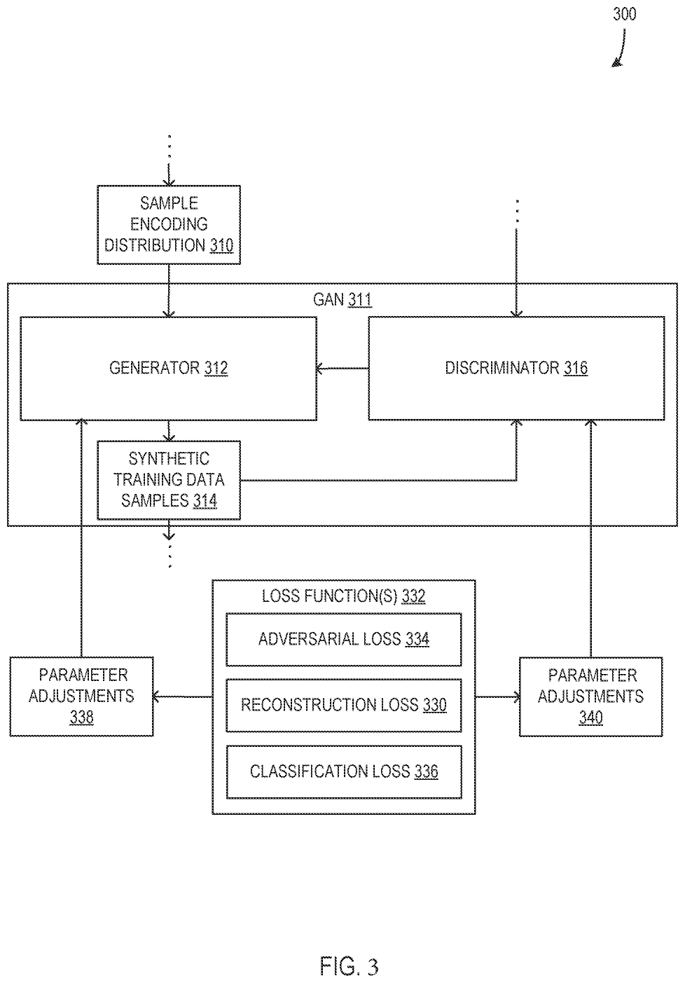

The generator 112 includes hardware, firmware, and/or software configured to generate synthetic training data samples 114 using sample encodings 110. Further, the discriminator 116 includes hardware, firmware, and/or software configured to distinguish between real training data samples 102 and synthetic training data samples 114. In some examples, the generator 112 and the discriminator 116 are configured as a Generative Adversarial Network (GAN) that is trained using machine learning techniques including adversarial training to improve the performance of the generator 112 in generating accurate synthetic training data samples and to improve the performance of the discriminator 116 in distinguishing between real and synthetic training data samples. In such examples, the GAN is trained iteratively until the generator 112 is capable of generating synthetic training data samples 114 that the trained discriminator 116 is capable of distinguishing from real training data samples 102 at a defined rate, such as 50% of the time. The generator 112 and discriminator 116 as a GAN is described in greater detail below with respect to FIG. 3.

In some examples, the synthetic training data samples 114 include the same types of data and/or the same data structures as are present in the real training data samples 102. For instance, in some examples, the synthetic training data samples 114 include feature data 104 associated with a supplier or other entity that is linked to a health indicator 106 of that supplier or entity. In some such examples, the suppliers or other entities represented in the synthetic training data samples include existing suppliers/entities and/or synthetically generated supplier/entity identifiers that do not refer to any existing suppliers or other entities.

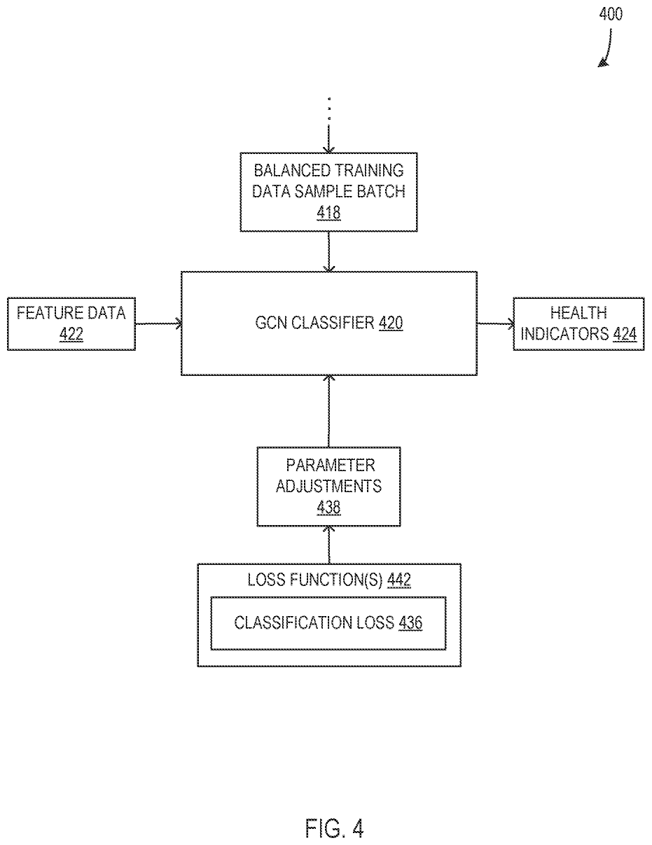

The classifier 120 includes hardware, firmware, and/or software configured to classify feature data 122 of a supplier as “healthy” or “unhealthy” by generating health indicators 124. In some examples, the classifier 120 is configured as a model that can be trained using machine learning techniques and a balanced training data sample batch 118. Further, in some examples, the classifier 120 is a Graph Convolutional Network (GCN)-based binary classifier. In such examples, the classifier 120 is configured to analyze the feature data 122 using The classifier 120 as a GCN-based binary classifier is described in greater detail below with respect to FIG. 4.

Further, in some examples, the training of the encoder 108, the generator 112, and/or the discriminator 116 is also based on the classification output generated by the classifier 120 during training thereof. Thus, as the classifier 120 is trained using the synthetic training data samples 114 generated by the generator 112, the output of the classifier 120 (e.g., health indicators 124 of suppliers that are represented in the synthetic training data samples 114) is used to adjust the parameters of at least one of the encoder 108, the generator 112, and/or the discriminator 116, in addition to being used to adjust parameters of the classifier 120. In other examples, more, fewer, or different types of data are used to adjust the parameters of the components of system 100 without departing from the description.

FIG. 2 is a diagram 200 illustrating configuration and training of a VAE in the system 100 of FIG. 1. In some examples, the sample encoding distribution 210 is provided to another component of the system as described above with respect to system 100 of FIG. 1. As described above, the VAE 208 is configured to generate a sample encoding distribution 210 from the real training data samples 202 based on the feature data 204 and/or the health indicators 206 thereof. During a training process of the VAE 208, loss functions 226 are computed and the results of those loss functions 226 are used to perform parameter adjustments 232 on the VAE 208. In some such examples, the VAE 208 is trained iteratively, such that multiple rounds of the training process are performed on the VAE 208.

In some examples, the VAE 208 is trained using a regularized process to avoid overfitting and ensure that the latent space of the encodings has properties that are compatible with enabling the generation of synthetic sample encodings. Such a regularized training process includes encoding the input as a distribution over the latent space, sampling a point of that distribution from the latent space, decoding the sampled point, computing the reconstruction error or loss, and backpropagating the reconstruction error through the network of the VAE 208 to train it. In such examples, the input is encoded as a distribution with variance in order to accurately represent the latent space (e.g., the distributions returned by the encoder are enforced to be close to the standard normal distribution).

Further, in some examples, the parameter adjustments 232 of the VAE 208 are expressed as a function of parameters of the VAE 208, a learning rate of the learning process, a gradient function associated with the VAE 208, a divergence loss function 228, and a reconstruction loss function 230. In some examples, the parameter adjustments 232 of the VAE 208 are expressed in the following equation:

$${θ}_{enc} = {θ}_{enc} - η {∇}_{enc} ( {L}_{KL} + {L}_{recons} ) \qquad ( 1 )$$

In the above equation 1, θ_{enc} represents the parameters of the VAE 208, n represents the learning rate of the learning process, and ∇_{enc} represents the gradient function associated with training the VAE 208. The L_{KL} is the divergence loss function 228, specifically the Kullback Leibler (KL) Loss and the L_{recons} is the reconstruction loss function 230. In other examples, other loss functions are used without departing from the description. In the above equation, the gradient function controls how the parameters of the VAE 208 are adjusted, and the learning rate controls the degree to which the parameters are adjusted during an iteration of the training process. The two loss functions compare outputs of the system to inputs of the system as described below and inform the gradient function as to adjustments that are to be made.

In some examples, the L_{KL} is computed according to the following equation:

$${L}_{KL} = {D}_{KL} ( p ( z \vert x ) ‖ q ( z ) ) , where q ( z ) = N ( 0 , 1 ) \qquad ( 2 )$$

In the above Equation 2, D_{KL} represents a divergence function that is configured to compute the divergence between the probability distribution p(z|x), which is the probability distribution of the sample encoding distribution 210, and q(z), which is defined as N(0,1), the Standard Normal Distribution in which the mean is zero and the standard deviation is one. The loss is calculated, and the VAE 208 (and other components of the system 100) are trained to reduce and/or minimize the divergence. In this way, the VAE 208 is trained to generate normalized encoding distributions that enable the generation of accurate synthetic training data samples as described herein.

In some examples, the L_{recons} is computed according to the following equation:

$${L}_{recons} = mse ( x , {x}^{′} ) \qquad ( 3 )$$

In the above Equation 3, the reconstruction loss L_{recons} is calculated by calculating the mean square error, using mse( ) of the real samples x (e.g., the real training data samples 102) and the synthetic samples x′ (e.g., the synthetic training data samples 114). The reconstruction loss is used in the training of the VAE 208 to improve the degree to which the sample encoding distribution 210 accurate represents the real training data samples 202, thus improving the accuracy of the input data provided to the GAN as described herein.

As illustrated, the VAE 208 is trained toward two goals: generating a sample encoding distribution 210 that accurately represents the real training data samples 202 and generating a sample encoding distribution 210 that is normally distributed.

FIG. 3 is a diagram 300 illustrating configuration and training of a Generative Adversarial Network (GAN) 311 in the system 100 of FIG. 1. In some examples, the sample encoding distribution 310 is received by the generator 312 and synthetic training data samples 314 are generated by the generator 312 as described herein. The synthetic training data samples 314 are provided to the discriminator 316 and the discriminator 316 is configured to distinguish between the synthetic training data samples 314 and real training data samples (e.g., real training data samples 102). During a training process of the GAN 311, loss functions 332 are computed and the results of those loss functions 332 are used to perform parameter adjustments 338 on the generator 312 and parameter adjustments 340 on the discriminator 316. In some such examples, the GAN 311 is trained iteratively, such that multiple rounds of the training process are performed on the GAN 311.

In some examples, the generator 312 is configured to take in random vectors from the sample encoding distribution 310 and to use those vectors as seeds in the generation of synthetic training data samples 314. Because the sample encoding distribution 310 is generated by an encoder, such as the VAE described above, using the real training data samples, the vectors extracted from the distribution 310 depend on and/or are related to the real training data samples. In such examples, the generator 312 is configured to analyze the vectors with respect to the latent space of the distribution 310 and to generate synthetic training samples 314 therefrom (e.g., including feature data 104 and associated health indicators 106). The training process of the generator 312 includes performing parameter adjustments 338 of the generator 312 based on the adversarial loss function 334, the reconstruction loss function 330, and/or the classification loss function 336. The adjustments are performed in order to improve the accuracy of the generated synthetic training data samples 314 with respect to the real training data samples from which they are generated. In this case, an “accurate” synthetic training data sample 314 is one which fits into patterns of the existing real training data samples (e.g., feature data values that fall within reasonable ranges from the real data, heath indicators associated with feature data patterns that are similar to feature data patterns of health indicators of that class in the real data, or the like).

In some examples, the parameter adjustments 338 of the generator 312 are expressed as the following equation:

$${θ}_{gen} = {θ}_{gen} - η {∇}_{gen} ( {L}_{recons} - {L}_{GAN} + {L}_{cls} ) \qquad ( 4 )$$

In the above Equation (4), θ_{gen} represents the parameters of the generator 312, n represents a learning rate of the learning process, and ∇_{gen} represents a gradient function associated with training the generator 312. The L_{recons} is a reconstruction loss function 330, the L_{GAN} is an adversarial loss function 334, and the L_{cls} is a classification loss function 336. In other examples, other loss functions are used without departing from the description. In the above equation, the gradient function controls how the parameters of the generator 312 are adjusted, and the learning rate controls the degree to which the parameters are adjusted during an iteration of the training process. The three loss functions compare outputs of the system to inputs of the system as described below and inform the gradient function as to adjustments that are to be made.

In some examples, the reconstruction loss function 330 is the same loss function as the reconstruction loss function 230 of FIG. 2 as described above. In such examples, the reconstruction loss function 330 may be expressed as equation 3, as described above.

Further, in some examples, the adversarial loss function 334 is expressed as the following equation:

$${L}_{GAN} = log ( Dis ( x ) ) + log ( 1 - Dis ( Gen ( z ) ) ) \qquad ( 5 )$$

In the above Equation (5), Dis( ) is the function of the discriminator 316 and Gen( ) is the function of the generator 312. This loss function expresses the adversarial objectives of the generator 312 and the discriminator 316, in that the discriminator's objective is to distinguish between real training data samples and synthetic training data samples and the generator's objective is to “fool” the discriminator, such that it cannot distinguish between real samples and synthetic samples. The first term of the equation (log(Dis(x))) represents the application of the discriminator 316 to x, which represents the real training data samples. The second term of the equation (log(1−Dis(Gen(z)) represents the application of the discriminator 316 to the output of the generator 312 when the generator 312 is applied to z, which represents data of the sample encoding distribution 310. Thus, Gen(z) represents the synthetic training data samples 314 of the generator 312. The second term is inverted (the result of the discriminator 316 function is subtracted from one), such that by adding the two terms together, the positive value of the first term associated with the real training data samples is compared to the negative value of the second term. A larger difference between the first term and the second term results in a larger loss, while a smaller difference between the first term and the second term results in a smaller loss.

Still further, in some examples, the classification loss function 336 is expressed as the following equation:

$${L}_{cls} = - y log ( Cls ( {x}^{′} ) ) - ( 1 - y ) log ( 1 - Cls ( {x}^{′} ) ) \qquad ( 6 )$$

In the above Equation (6), Cls( ) is the function of a classifier of the system (e.g., classifier 120), x′ represents the synthetic training data samples 314, and y represents the health indicators (e.g., health indicators 106). The equation expresses a cross-entropy loss function that is used in the training of the classifier as well as the generator 312.

In some examples, the discriminator 316 is configured as a classifier that is trained to classify training data samples received as input as real or synthetic. The training data for the discriminator 316 includes the real training data samples and the synthetic training data samples 314 as described herein. The training of the discriminator 316 includes providing those training data samples to the discriminator 316 and then performing parameter adjustments 340 on the discriminator 316 based on the degree to which its classification of the input as real or synthetic training data samples is accurate.

Further, in some examples, the parameter adjustments 340 of the discriminator 316 are expressed as the following equation:

$${θ}_{dis} = {θ}_{dis} - η {∇}_{dis} ( {L}_{GAN} ) \qquad ( 7 )$$

In the above Equation (7), θ_{dis} represents the parameters of the discriminator 316, n represents a learning rate of the learning process, and ∇_{dis} represents a gradient function associated with training the discriminator 316. The L_{GAN} is the adversarial loss function 334 as described above. In other examples, other loss functions are used without departing from the description. In the above equation, the gradient function controls how the parameters of the discriminator 316 are adjusted, and the learning rate controls the degree to which the parameters are adjusted during an iteration of the training process. The adversarial loss function 334 compares outputs of the system to inputs of the system as described herein and informs the gradient function as to adjustments that are to be made.

FIG. 4 is a diagram 400 illustrating configuration and training of a GCN-based classifier 420 in the system of FIG. 1. In some examples, the balanced training data sample patch 418 is received from another component of the system, such as the generator 112, as described above with respect to system 100 of FIG. 1. As described above, the GCN classifier 420 is configured to classify sets of feature data 422 with health indicators 424. The health indicators 424 indicate whether a supplier or other entity with which a set of feature data 422 is associated has a healthy or unhealthy business relationship with a service provider as described herein. During a training process of the GCN classifier 420, a loss functions 442 are computed and the results of those loss functions 442 are used to perform parameter adjustments 438 on the GCN classifier 420. In some such examples, the classifier 420 is trained iteratively, such that multiple rounds of the training process are performed on the classifier 420.

In some examples, the GCN classifier 420 is configured to learn discriminative features from input graph-structured data (e.g., the balanced training data sample batch 418 in a graph structure). In such a graph structure, feature data from the graph is obtained from a particular feature data entry and its neighbors in the graph. A function, such as an average function, is used to aggregate or otherwise combine the feature data from the multiple entries into a value that is used in the next layer of the classifier 420 network. This convolution process is continued throughout the operation of the classifier 420. It should be understood that, in some examples, the GCN classifier 420 is configured to be trained and to operate as a GCN-based classifier as would be understood by a person of ordinary skill in the art without departing from the description.

Further, in some examples, the parameter adjustments 438 of the GCN classifier 420 are expressed as the following equation:

$${θ}_{GCN} = {θ}_{GCN} - η {∇}_{GCN} ( {L}_{Cls} ) \qquad ( 8 )$$

In the above Equation (8), θ_{GCN} represents the parameters of the GCN classifier 420, n represents a learning rate of the learning process, and ∇_{GCN} represents a gradient function associated with training the GCN classifier 420. The Lets is the classification loss function 436 as previously described above with respect to classification loss function 336 of FIG. 3. In other examples, other loss functions are used without departing from the description. In the above equation, the gradient function controls how the parameters of the GCN classifier 420 are adjusted, and the learning rate controls the degree to which the parameters are adjusted during an iteration of the training process. The classification loss function 436 compares outputs of the system to inputs of the system as described herein and inform the gradient function as to adjustments that are to be made.

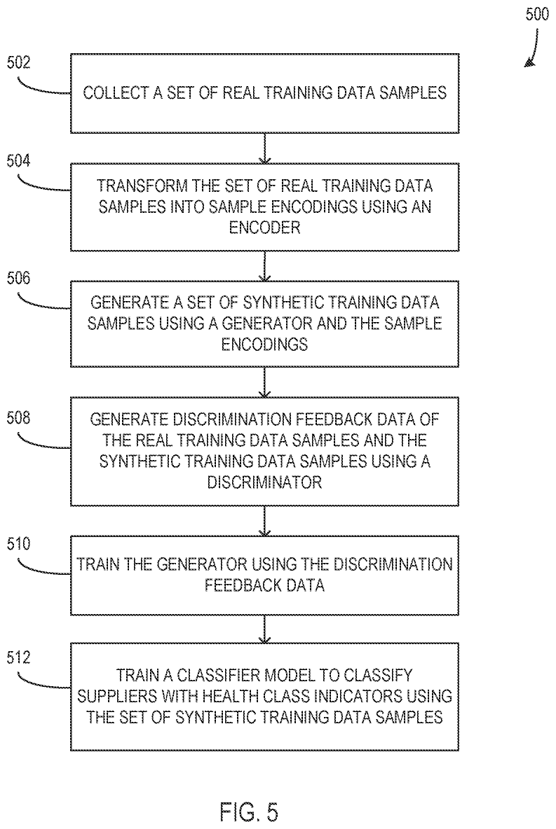

FIG. 5 is a flowchart illustrating a method 500 for training a classifier model (e.g., classifier 120) to classify suppliers with health class indicators (e.g., health indicators 124). In some examples, the method 500 is executed or otherwise performed by or in association with a system such as system 100 of FIG. 1.

At 502, a set of real training data samples are collected. In some examples, the set of real training data samples include feature data associated with a plurality of suppliers that are using or have used a service provided by a service providing entity. Further, the feature data of the plurality of suppliers is associated with health class indicators that are indicative of the health of the relationship between each supplier and the service providing entity, wherein a “healthy” relationship indicates that the supplier is likely to continue using the service while an “unhealthy” relationship indicates that the supplier is unlikely to continue using the service, as described herein. In some such examples, the set of real training data samples is class-unbalanced, such that there are significantly more healthy relationships represented in the data than there are unhealthy relationships.

Further, in an example, the set of real training data samples includes data associated with a plurality of supplier entities that make use of services provided by a service provider. The feature data of the real training data samples includes transaction data associated with transactions between the supplier entities and the service provider, including the frequency of the transactions and quantity and/or type of services purchased with the transactions. The health indicators of the real training data samples classify the relationships of the supplier entities with the service provider as healthy or unhealthy based on whether a supplier entity continued to use the services of the service provider for a defined time period, such as 3 months, 6 months, or the like. Additionally, or alternatively, the health indicators are determined based on whether the quantity and/or type of transactions between the supplier entity and the service provider increased, decreased, changed, or remained the same.

At 504, the set of real training data samples are transformed into sample encodings using an encoder. In some examples, the encoder is a VAE as described herein. At 506, the sample encodings are used to generate a set of synthetic training data samples using a generator. In some examples, the generator is part of a GAN as described herein.

In the above example using transaction data as feature data, the feature data, including the transaction data of transactions between the supplier entities and the service provider, and the health indicators associated with the supplier entities are encoded or otherwise transformed into encoding vectors using the VAE as described herein. It should be understood that the resulting encoding vectors include a quantity of vector dimensions with associated values and that the values of the encoding vectors are representative of the associated feature data and health indicators used to generate the encoding vectors.

At 508, discrimination feedback data is generated using a discriminator based on the real training data samples and the synthetic training data samples. In some examples, the discrimination feedback data includes indicators for each training data sample indicating whether the discriminator determined that the training data sample is real or synthetic. At 510, the generator is trained using the discriminator feedback data, such that the performance of the generator with respect to generating synthetic training data samples that are similar to the real training data samples is improved.

In the above example using transaction data as feature data, the encoding vectors generated by the VAE are used to generate additional synthetic training data samples using a generator of a GAN as described herein. It should be understood that the synthetic training data samples include feature data, including synthetic transaction data, and associated synthetic health indicators. Further, the generator of the GAN is configured to generate feature data paired with health indicators in a way such that the synthetic feature data (e.g., patterns of synthetic transaction data) associated with healthy health indicators is substantially similar to feature data of real training data samples that have healthy health indicators and the synthetic feature data associated with unhealthy health indicators is substantially similar to feature data of real training data samples that have unhealthy health indicators.

Further, in such an example, the discriminator is configured to analyze the synthetic feature data and the real feature data and determine whether the data are synthetic or real, which is then used as discrimination feedback data as described herein.

At 512, a classifier model is trained to classify suppliers with health class indicators using the set of synthetic training data samples. In some examples, the set of synthetic training data samples is generated to be class-balanced, such that the quantity of healthy supplier relationships represented therein is substantially the same as the quantity of unhealthy supplier relationships represented therein. The class balancing of the synthetic training data samples better enables the training of the classifier model. Further, by generating the synthetic training data samples, substantially more training data can be created and used to train the classifier model, enabling faster and more effective training of the classifier model.

In the above example using transaction data as feature data, the synthetic transaction data of synthetic supplier entities is provided to the classifier model and the classifier model classifies the synthetic transaction data as being associated with relationships that are healthy or unhealthy. The accuracy of this classification process is used as classification feedback data that is used to train and improve the accuracy of the classifier model as described herein.

After training, the classifier model is used to classify suppliers with health class indicators using the set of synthetic training data samples.

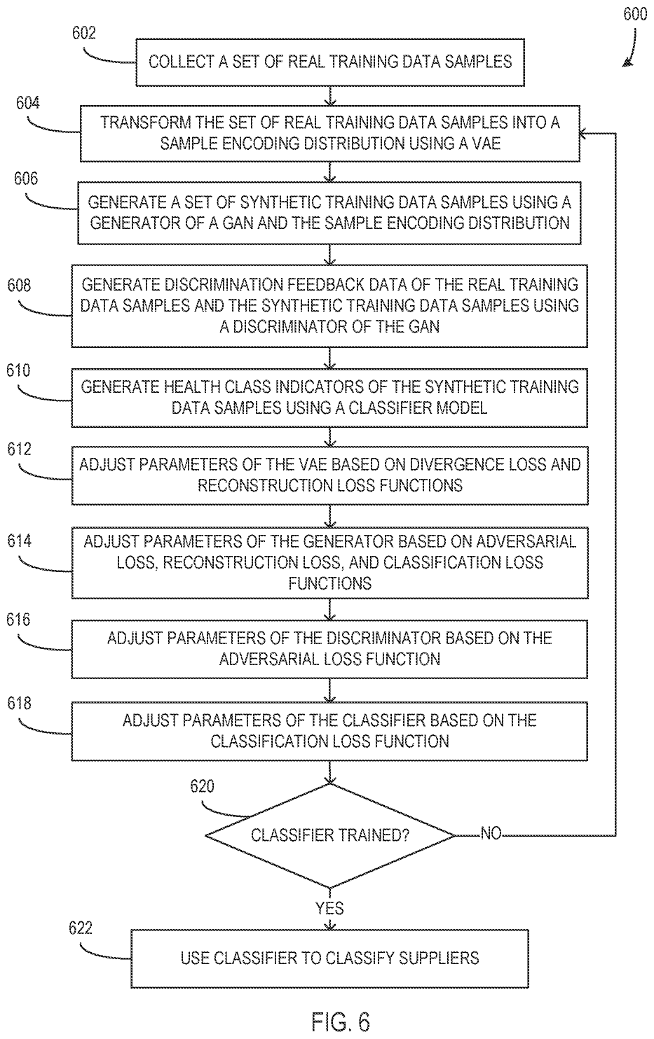

FIG. 6 is a flowchart illustrating a method 600 for iteratively training a series of models for classifying suppliers with health class indicators. In some examples, the method 600 is executed or otherwise performed by or in association with a system such as system 100 of FIG. 1. Further, in some examples, portions of the method 600 are performed in substantially the same way as the method 500 as described above (e.g., collecting the set of real training data samples at 602 is substantially the same as collecting the set of real training data samples at 502).

At 602, a set of real training data samples is collected and, at 604, the set of real training data samples is transformed into a sample encoding distribution using a VAE (e.g., the VAE 208 of FIG. 2). In some examples, the sample encoding distribution is normalized as described herein with respect to the VAE 208.

At 606, a set of synthetic training data samples is generated using a generator of a GAN and the sample encoding distribution. At 608, discrimination feedback data of the real training data samples and the synthetic training data samples is generated using a discriminator of the GAN. In some examples, the generator and discriminator of the GAN are configured to engage in adversarial training processes as described herein. In some such examples, the generator is trained to generate synthetic training data samples that are increasingly similar to the real training data samples and the discriminator is trained to become more accurate at differentiating between real and synthetic training data samples.

At 610, health class indicators are generated for the synthetic training data samples using a classifier model. In some examples, these generated health class indicators are used to calculate a classification loss function for use in training the components of the described system, including the classifier model.

At 612, parameters of the VAE are adjusted based on divergence loss and reconstruction loss functions. In some examples, the divergence loss function represented differences between the distribution generated by the VAE and a standard normal distribution, while the reconstruction loss represents differences between the synthetic training data samples generated by the generator and the real training data samples. Thus, the VAE is trained to encode the real training data samples more accurately and to normalize a distribution of the encodings more accurately.

At 614, parameters of the generator of the GAN are adjusted based on an adversarial loss function, the reconstruction loss function, and the classification loss function. In some such examples, the adversarial loss function is based on the performance of the generator and discriminator as described herein. Further, at 616, parameters of the discriminator of the GAN are also adjusted based on the adversarial loss function as described herein. In some examples, the training method 600 is performed iteratively until an accuracy level of the discrimination feedback data reaches a defined threshold range. For instance, in an example, defined threshold range is 47%-53%, such that training of the components of the GAN is considered complete when the accuracy of the discrimination feedback data falls within that range. Further, in some examples, the iterative training of the components of the GAN is also based on the accuracy of the generated synthetic training data samples in comparison to the real training data samples as described herein.

At 618, parameters of the classifier are adjusted based on the classification loss function. In some such examples, the parameters are adjusted such that the classifier more accurately generates health class indicators when provided feature data of suppliers as described herein.

At 620, if the classifier training is complete, the process proceeds to 622. Alternatively, if the classifier training is not complete, the process returns to 604 to iterate through the training method 600 again. In some examples, the completeness of the classifier training is determined based on a measured accuracy of the generated health class indicators and whether that measured accuracy meets or exceeds a defined accuracy threshold. For instance, in an example, the classifier is considered completely trained with its measured accuracy is greater than or equal to 95%. In other examples, other thresholds are used without departing from the description.

At 622, after the classifier is completely trained, it is used to classify suppliers based on feature data associated therewith. In some examples, the use of the classifier includes receiving a set of feature data associated with a target supplier and classifying the target supplier with a health class indicator using the classifier and the received set of feature data. The classifications, in the form of health class indicators, are used to determine actions to be taken by the service providing entity with respect to each classified supplier. For instance, in an example, the service providing entity takes actions to improve the health of the relationships with suppliers that are classified with unhealthy health class indicators.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. In some examples, platform software comprising an operating system 720 or any other suitable platform software is provided on the apparatus 718 to enable application software 721 to be executed on the device. In some examples, training a classifier model to classify relationships of suppliers and service providers using limited real training data samples as described herein is accomplished by software, hardware, and/or firmware.

In some examples, computer executable instructions are provided using any computer-readable media that are accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to. Random Access Memory (RAM). Read-Only Memory (ROM). Erasable Programmable Read-Only Memory (EPROM). Electrically Erasable Programmable Read-Only Memory (EEPROM), persistent memory, phase change memory, flash memory or other memory technology. Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to, with the processor, cause the processor to: collect a set of real training data samples, wherein the real training data samples include feature data associated with health class indicators, wherein the health class indicators are indicative of a likelihood of a supplier to continue using a service provided by a service provider; transform the set of real training data samples into sample encodings using an encoder; generate a set of synthetic training data samples using a generator and the sample encodings; generate discrimination feedback data of the real training data samples and the synthetic training data samples using a discriminator; train the generator using the generated discrimination feedback data; and train a classifier model to classify suppliers with health class indicators using the set of synthetic training data samples.

An example computerized method comprises: collecting a set of real training data samples, wherein the real training data samples include feature data associated with health class indicators, wherein the health class indicators are indicative of a likelihood of a supplier to continue using a service provided by a service provider; transforming the set of real training data samples into sample encodings using an encoder; generating a set of synthetic training data samples using a generator and the sample encodings; generating discrimination feedback data of the real training data samples and the synthetic training data samples using a discriminator; training the generator using the generated discrimination feedback data; and training a classifier model to classify suppliers with health class indicators using the set of synthetic training data samples.

One or more computer storage media have computer-executable instructions that, upon execution by a processor, cause the processor to at least: collect a set of real training data samples, wherein the real training data samples include feature data associated with health class indicators, wherein the health class indicators are indicative of a likelihood of a supplier to continue using a service provided by a service provider; transform the set of real training data samples into sample encodings using an encoder; generate a set of synthetic training data samples using a generator and the sample encodings; generate discrimination feedback data of the real training data samples and the synthetic training data samples using a discriminator; train the generator using the generated discrimination feedback data; and train a classifier model to classify suppliers with health class indicators using the set of synthetic training data samples.

Alternatively, or in addition to the other examples described herein, examples include any combination of the following:
wherein the encoder is a Variational Autoencoder (VAE); wherein the sample encodings include a normalized encoding distribution; and the computerized method further comprises training the encoder using: a divergence loss function based on the normalized encoding distribution and a standard normal distribution; and a reconstruction loss function based on the synthetic training data samples and the real training data samples.
wherein the generator and discriminator are components of a Generative Adversarial Network (GAN); and wherein training the generator includes training the generator using: a reconstruction loss function based on the synthetic training data samples and the real training data samples; an adversarial loss function based on the discrimination feedback data of the discriminator; and a classification loss function based on classification output data from the classifier model; and wherein the discriminator is trained using the adversarial loss function based on the discrimination feedback data of the discriminator.
wherein training the generator and training the discriminator further includes training the generator and the discriminator iteratively until an accuracy level of the discrimination feedback data reaches a defined threshold range.
wherein the classifier model is a Graph Convolutional Network (GCN)-based model; and wherein training the classifier model includes training the classifier model using a classification loss function that is a cross-entropy loss function based on classification output data of the classifier model.
further comprising: receiving a set of feature data associated with a target supplier; and classifying the target supplier with a health class indicator using the trained classifier model and the received set of feature data.
wherein the real training data samples are class-imbalanced in that a difference between a quantity of real training data samples associated with a healthy health class indicator and a quantity of real training data samples associated with an unhealthy health class indicator exceeds a defined threshold; and wherein generating the set of synthetic training data samples includes generating a class-balanced set of synthetic training data samples in that a difference between a quantity of synthetic training data samples associated with a healthy health class indicator and a quantity of synthetic training data samples associated with an unhealthy health class indicator is within the defined threshold.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for collecting a set of real training data samples, wherein the real training data samples include feature data associated with health class indicators, wherein the health class indicators are indicative of a likelihood of a supplier to continue using a service provided by a service provider; exemplary means for transforming the set of real training data samples into sample encodings using an encoder; exemplary means for generating a set of synthetic training data samples using a generator and the sample encodings; exemplary means for generating discrimination feedback data of the real training data samples and the synthetic training data samples using a discriminator; exemplary means for training the generator using the generated discrimination feedback data; and exemplary means for training a classifier model to classify suppliers with health class indicators using the set of synthetic training data samples.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to, with the processor, cause the processor to:
collect a set of real training data samples, wherein the real training data samples include feature data associated with health class indicators, wherein the health class indicators are indicative of a likelihood of a supplier to continue using a service provided by a service provider;
transform the set of real training data samples into sample encodings using an encoder;
generate a set of synthetic training data samples using a generator and the sample encodings;
generate discrimination feedback data of the real training data samples and the synthetic training data samples using a discriminator;
train the generator using the generated discrimination feedback data; and
train a classifier model to classify suppliers with health class indicators using the set of synthetic training data samples.

2. The system of claim 1, wherein the encoder is a Variational Autoencoder (VAE):
wherein the sample encodings include a normalized encoding distribution; and
wherein the memory and the computer program code are configured to, with the processor, further cause the processor to train the encoder using:
a divergence loss function based on the normalized encoding distribution and a standard normal distribution; and
a reconstruction loss function based on the synthetic training data samples and the real training data samples.

3. The system of claim 1, wherein the generator and discriminator are components of a Generative Adversarial Network (GAN); and
wherein training the generator includes training the generator using:
a reconstruction loss function based on the synthetic training data samples and the real training data samples;
an adversarial loss function based on the discrimination feedback data of the discriminator; and
a classification loss function based on classification output data from the classifier model; and
wherein the memory and the computer program code are configured to, with the processor, further cause the processor to train the discriminator using the adversarial loss function based on the discrimination feedback data of the discriminator.

4. The system of claim 3, wherein training the generator and training the discriminator further includes training the generator and the discriminator iteratively until an accuracy level of the discrimination feedback data reaches a threshold range.

5. The system of claim 1, wherein the classifier model is a Graph Convolutional Network (GCN)-based model; and
wherein training the classifier model includes training the classifier model using a classification loss function that is a cross-entropy loss function based on classification output data of the classifier model.

6. The system of claim 1, wherein the memory and the computer program code are configured to, with the processor, further cause the processor to:
receive a set of feature data associated with a target supplier; and
classify the target supplier with a health class indicator using the trained classifier model and the received set of feature data.

7. The system of claim 1, wherein the real training data samples are class-imbalanced in that a difference between a quantity of real training data samples associated with a healthy health class indicator and a quantity of real training data samples associated with an unhealthy health class indicator exceeds a threshold; and
wherein generating the set of synthetic training data samples includes generating a class-balanced set of synthetic training data samples in that a difference between a quantity of synthetic training data samples associated with a healthy health class indicator and a quantity of synthetic training data samples associated with an unhealthy health class indicator is within the threshold.

8. A computerized method comprising:
collecting a set of real training data samples, wherein the real training data samples include feature data associated with health class indicators, wherein the health class indicators are indicative of a likelihood of a supplier to continue using a service provided by a service provider;
transforming the set of real training data samples into sample encodings using an encoder;
generating a set of synthetic training data samples using a generator and the sample encodings;
generating discrimination feedback data of the real training data samples and the synthetic training data samples using a discriminator;
training the generator using the generated discrimination feedback data; and
training a classifier model to classify suppliers with health class indicators using the set of synthetic training data samples.

9. The computerized method of claim 8, wherein the encoder is a Variational Autoencoder (VAE):
wherein the sample encodings include a normalized encoding distribution; and
the computerized method further comprises training the encoder using:
a divergence loss function based on the normalized encoding distribution and a standard normal distribution; and
a reconstruction loss function based on the synthetic training data samples and the real training data samples.

10. The computerized method of claim 8, wherein the generator and discriminator are components of a Generative Adversarial Network (GAN); and
wherein training the generator includes training the generator using:
a reconstruction loss function based on the synthetic training data samples and the real training data samples;
an adversarial loss function based on the discrimination feedback data of the discriminator; and
a classification loss function based on classification output data from the classifier model; and
wherein the discriminator is trained using the adversarial loss function based on the discrimination feedback data of the discriminator.

11. The computerized method of claim 10, wherein training the generator and training the discriminator further includes training the generator and the discriminator iteratively until an accuracy level of the discrimination feedback data reaches a threshold range.

12. The computerized method of claim 8, wherein the classifier model is a Graph Convolutional Network (GCN)-based model; and
wherein training the classifier model includes training the classifier model using a classification loss function that is a cross-entropy loss function based on classification output data of the classifier model.

13. The computerized method of claim 8, further comprising:
receiving a set of feature data associated with a target supplier; and
classifying the target supplier with a health class indicator using the trained classifier model and the received set of feature data.

14. The computerized method of claim 8, wherein the real training data samples are class-imbalanced in that a difference between a quantity of real training data samples associated with a healthy health class indicator and a quantity of real training data samples associated with an unhealthy health class indicator exceeds a threshold; and
wherein generating the set of synthetic training data samples includes generating a class-balanced set of synthetic training data samples in that a difference between a quantity of synthetic training data samples associated with a healthy health class indicator and a quantity of synthetic training data samples associated with an unhealthy health class indicator is within the threshold.

15. One or more computer storage media having computer-executable instructions that, upon execution by a processor, cause the processor to at least:
collect a set of real training data samples, wherein the real training data samples include feature data associated with health class indicators, wherein the health class indicators are indicative of a likelihood of a supplier to continue using a service provided by a service provider;
transform the set of real training data samples into sample encodings using an encoder;
generate a set of synthetic training data samples using a generator and the sample encodings;
generate discrimination feedback data of the real training data samples and the synthetic training data samples using a discriminator;
train the generator using the generated discrimination feedback data; and
train a classifier model to classify suppliers with health class indicators using the set of synthetic training data samples.

16. The one or more computer storage media of claim 15, wherein the encoder is a Variational Autoencoder (VAE):
wherein the sample encodings include a normalized encoding distribution; and
wherein the computer-executable instructions, upon execution by a processor, further cause the processor to at least train the encoder using:
a divergence loss function based on the normalized encoding distribution and a standard normal distribution; and
a reconstruction loss function based on the synthetic training data samples and the real training data samples.

17. The one or more computer storage media of claim 15, wherein the generator and discriminator are components of a Generative Adversarial Network (GAN); and
wherein training the generator includes training the generator using:
a reconstruction loss function based on the synthetic training data samples and the real training data samples;
an adversarial loss function based on the discrimination feedback data of the discriminator; and
a classification loss function based on classification output data from the classifier model; and
wherein the computer-executable instructions, upon execution by a processor, further cause the processor to at least train the discriminator using the adversarial loss function based on the discrimination feedback data of the discriminator.

18. The one or more computer storage media of claim 17, wherein training the generator and training the discriminator further includes training the generator and the discriminator iteratively until an accuracy level of the discrimination feedback data reaches a threshold range.

19. The one or more computer storage media of claim 15, wherein the classifier model is a Graph Convolutional Network (GCN)-based model; and
wherein training the classifier model includes training the classifier model using a classification loss function that is a cross-entropy loss function based on classification output data of the classifier model.

20. The one or more computer storage media of claim 15, wherein the computer-executable instructions, upon execution by a processor, further cause the processor to at least:
receive a set of feature data associated with a target supplier; and
classify the target supplier with a health class indicator using the trained classifier model and the received set of feature data.
